(19) United States
(12) Patent Application Publication
(10) Pub. No.: US 2006/0133475 A1
(43) Pub. Date: Jun. 22, 2006

(54) Video coding

(76) Inventors: Wilhelmus Hendrikus Alfonsus Bruls, Eindhoven (NL); Reinier Bernardus Maria Klein Gunnewiek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/545,342

(22) PCT Filed: Feb. 4, 2004
(86) PCT No.: PCT/IB04/50074

§ 371 Date: Aug. 11, 2005

(30) Foreign Application Priority Data
Feb. 17, 2003 (EP) 03100350.2

(51) Int. Cl. H04B 1/66; H04N 11/04; H04N 7/12; H04N 11/02

(52) U.S. Cl. 375/240.1; 375/240.08; 375/240.16; 375/240.24; 375/240.12

(57) ABSTRACT

A method and apparatus for providing spatial scalable compression of an input video stream is disclosed. A base stream is encoded which comprises base features. A residual signal is encoded to produce an enhancement stream comprising enhancement features, wherein the residual signal is the difference between original frames of the input video stream an upscaled frames from the base layer. A processed version of the base features are subtracted from the enhancement features in the enhancement stream.

The invention relates to video coding, and more particularly to spatial scalable video compression schemes.

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high resolution video sequences are massive. In order to reduce the amount of data that must be sent, compression schemes are used to compress the data. Various video compression standards or processes have been established, including, MPEG-2, MPEG-_{4,} H.263, and H.264.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis, often referred to as signal-to-noise scalability or fine-grain scalability. The third axis is the resolution axis (number of pixels in image) often referred to as spatial scalability or layered coding. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

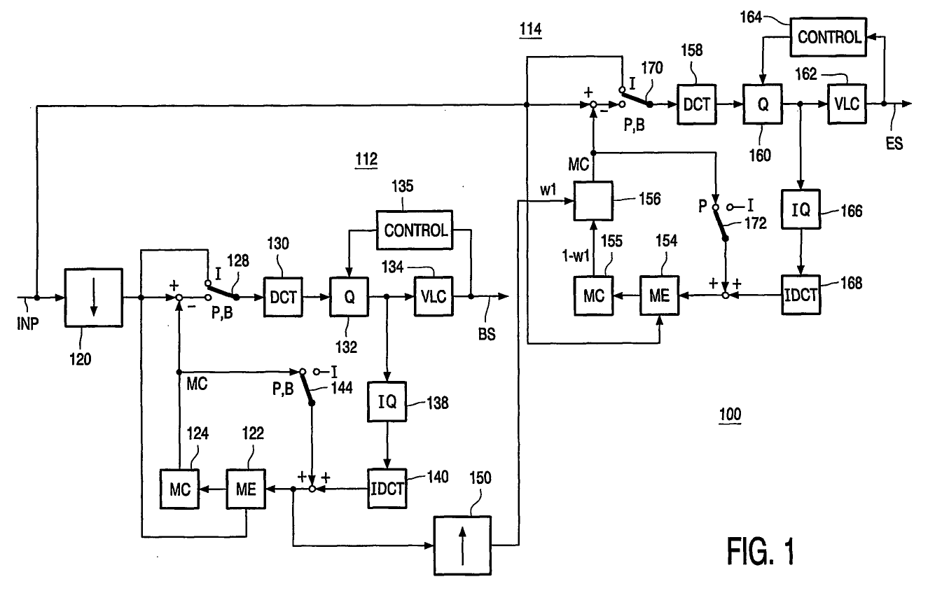

Most video compression standards support spatial scalability. FIG. 1 illustrates a block diagram of an encoder 100 which supports MPEG-2/MPEG-4 spatial scalability. The encoder 100 comprises a base encoder 112 and an enhancement encoder 114. The base encoder is comprised of a low pass filter and downsampler 120, a motion estimator 122, a motion compensator 124, an orthogonal transform (e.g., Discrete Cosine Transform (DCT)) circuit 130, a quantizer 132, a variable length coder 134, a bitrate control circuit 135, an inverse quantizer 138, an inverse transform circuit 140, switches 128, 144, and an interpolate and upsample circuit 150. The enhancement encoder 114 comprises a motion estimator 154, a motion compensator 155, a selector 156, an orthogonal transform (e.g., Discrete Cosine Transform (DCT)) circuit 158, a quantizer 160, a variable length coder 162, a bitrate control circuit 164, an inverse quantizer 166, an inverse transform circuit 168, switches 170 and 172. The operations of the individual components are well known in the art and will not be described in detail. The base encoder 112 produces a base stream BS and the enhancement encoder 114 produces an enhancement stream ES based on input INP.

Unfortunately, the coding efficiency of this layered coding scheme is not very good. Indeed, for a given picture quality, the bitrate of the base layer and the enhancement layer together for a sequence is greater than the bitrate of the same sequence coded at once.

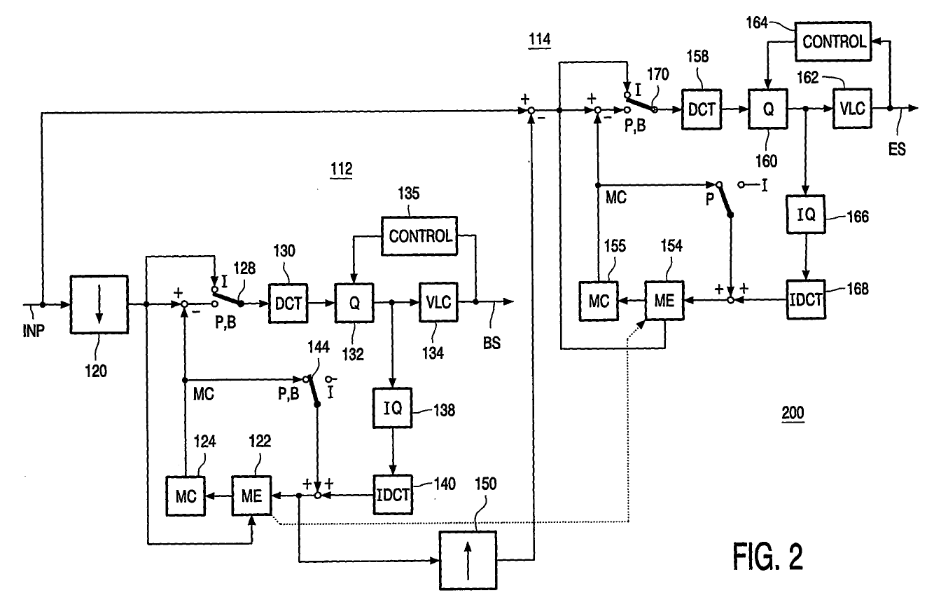

FIG. 2 illustrates another known encoder 200 proposed by DemoGrafx (see U.S. Pat. No. 5,852,565). The encoder is comprised of substantially the same components as the encoder 100 and the operation of each is substantially the same so the individual components will not be described. In this configuration, the residue difference between the input block and the upsampled output from the upsampler 150 is inputted into a motion estimator 154. To guide/help the motion estimation of the enhancement encoder, the scaled motion vectors from the base layer are used in the motion estimator 154 as indicated by the dashed line in FIG. 2. However, this arrangement does not significantly overcome the problems of the arrangement illustrated in FIG. 1.

While spatial scalability, as illustrated in FIGS. 1 and 2, is supported by the video compression standards, spatial scalability is not often used due to a lack of coding efficiency. The lack of efficient coding means that, for a given picture quality, the bit rate of the base layer and the enhancement layer for a sequence together are more than the bit rate of the same sequence coded at once.

It is an object of the invention to overcome at least part of the above-described deficiencies of the known spatial scalability schemes by providing a method and apparatus for providing more efficient compression by only transmitting a residual of enhancement features in the enhancement stream.

According to one embodiment of the invention, a method and apparatus for providing spatial scalable compression of an input video stream is disclosed. A base stream is encoded which comprises base features. A residual signal is encoded to produce an enhancement stream comprising enhancement features, wherein the residual signal is the difference between original frames of the input video stream an upscaled frames from the base layer. A processed version of the base features are subtracted from the enhancement features in the enhancement stream.

According to another embodiment of the invention, a method and apparatus for decoding compressed video information received in a base stream and an enhancement stream is disclosed. The received base stream is decoded. The resolution of the decoded base stream is upconverted. The base features produced by the base stream decoder are added to a residual motion vector signal in the received enhancement stream to form a combined signal. The combined signal is decoded. The upconverted decoded base stream and the decoded combined signal are added together to produce a video output.

These and other aspects of the invention will be apparent from and elucidated with reference to the embodiments described hereafter.

The invention will now be described, by way of example, with reference to the accompanying drawings, wherein:

FIG. 1 is a block schematic representation of a known encoder with spatial scalability;

FIG. 2 is a block schematic representation of a known encoder with spatial scalability;

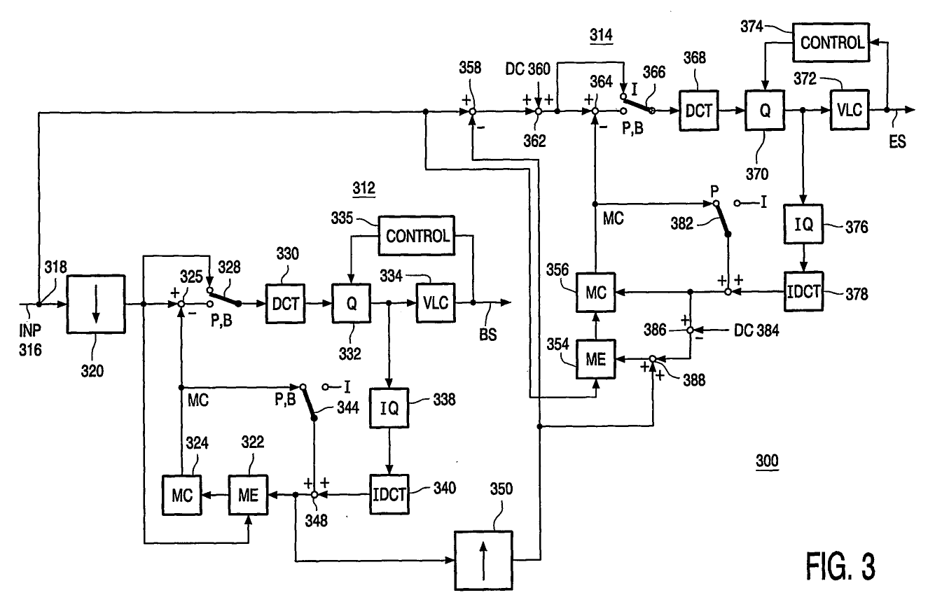

FIG. 3 is a block schematic representation of an encoder with spatial scalability according to one embodiment of the invention;

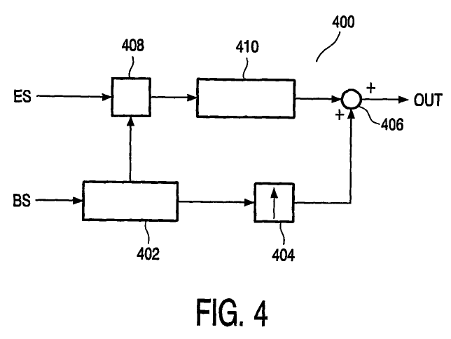

FIG. 4 is a block schematic representation of a layered decoder according to one embodiment of the invention.

FIG. 3 is a schematic diagram of an encoder according to one embodiment of the invention. As will be described below, the motion estimation performed by the encoder 300 is done on the complete image rather than the residual signal as illustrated in FIGS. 1 and 2. Since the motion estimation is done on the complete image, the motion estimation vectors of the base layer will have a high correlation with the corresponding vectors of the enhancement layer. Thus, the bitrate of the enhancement layer can be reduced by only transmitting the difference between the motion estimation vectors of the base layer and the enhancement layer as described below. While the illustrative embodiment illustrated in FIG. 3 refers to motion estimation and motion vectors, it will be understood by those skilled in the art that the invention applies to other base and enhancement features as well. According to the invention, information from the base layer can be used as a prediction for the enhancement layer. The encoding features selected in the base layer, e.g., macroblock-type, motion-type, etc., can be used to predict the encoding features used in the enhancement layer. By subtracting the base features from the enhancement features, an enhancement stream with a lower bitrate can be obtained.

The depicted encoding system 300 accomplishes layered compression, whereby a portion of the channel is used for providing a low resolution base layer and the remaining portion is used for transmitting edge enhancement information, whereby the two signals may be recombined to bring the system up to high resolution.

The encoder 300 comprises a base encoder 312 and an enhancement encoder 314. The base encoder is comprised of a low pass filter and downsampler 320, a motion estimator 322, a motion compensator 324, an orthogonal transform (e.g., Discrete Cosine Transform (DCT)) circuit 330, a quantizer 332, a variable length coder (VLC) 334, a bitrate control circuit 335, an inverse quantizer 338, an inverse transform circuit 340, switches 328, 344, and an interpolate and upsample circuit 350.

An input video block 316 is split by a splitter 318 and sent to both the base encoder 312 and the enhancement encoder 314. In the base encoder 312, the input block is inputted into a low pass filter and downsampler 320. The low pass filter reduces the resolution of the video block which is then fed to the motion estimator 322. The motion estimator 322 processes picture data of each frame as an I-picture, a P-picture, or as a B-picture. Each of the pictures of the sequentially entered frames is processed as one of the I-, P-, or B-pictures in a pre-set manner, such as in the sequence of I, B, P, B, P, . . . , B, P. That is, the motion estimator 322 refers to a pre-set reference frame in a series of pictures stored in a frame memory not illustrated and detects the motion vector of a macro-block, that is, a small block of 16 pixels by 16 lines of the frame being encoded by pattern matching (block Matching) between the macro-block and the reference frame for detecting the motion vector of the macro-block.

In MPEG, there are four picture prediction modes, that is an intra-coding (intra-frame coding), a forward predictive coding, a backward predictive coding, and a bi-directional predictive-coding. An I-picture is an intra-coded picture, a P-picture is an intra-coded or forward predictive coded or backward predictive coded picture, and a B-picture is an intra-coded, a forward predictive coded, or a bi-directional predictive-coded picture.

The motion estimator 322 performs forward prediction on a P-picture to detect its motion vector. Additionally, the motion estimator 322 performs forward prediction, backward prediction, and bi-directional prediction for a B-picture to detect the respective motion vectors. In a known manner, the motion estimator 322 searches, in the frame memory, for a block of pixels which most resembles the current input block of pixels. Various search algorithms are known in the art. They are generally based on evaluating the mean absolute difference (MAD) or the mean square error (MSE) between the pixels of the current input block and those of the candidate block. The candidate block having the least MAD or MSE is then selected to be the motion-compensated prediction block. Its relative location with respect to the location of the current input block is the motion vector.

Upon receiving the prediction mode and the motion vector from the motion estimator 322, the motion compensator 324 may read out encoded and already locally decoded picture data stored in the frame memory in accordance with the prediction mode and the motion vector and may supply the read-out data as a prediction picture to arithmetic unit 325 and switch 344. The arithmetic unit 325 also receives the input block and calculates the difference between the input block and the prediction picture from the motion compensator 324. The difference value is then supplied to the DCT circuit 330.

If only the prediction mode is received from the motion estimator 322, that is, if the prediction mode is the intra-coding mode, the motion compensator 324 may not output a prediction picture. In such a situation, the arithmetic unit 325 may not perform the above-described processing, but instead may directly output the input block to the DCT circuit 330.

The DCT circuit 330 performs DCT processing on the output signal from the arithmetic unit 325 so as to obtain DCT coefficients which are supplied to a quantizer 332. The quantizer 332 sets a quantization step (quantization scale) in accordance with the data storage quantity in a buffer (not illustrated) received as a feedback and quantizes the DCT coefficients from the DCT circuit 330 using the quantization step. The quantized DCT coefficients are supplied to the VLC unit 334 along with the set quantization step.

The VLC unit 334 converts the quantization coefficients supplied from the quantizer 332 into a variable length code, such as a Huffman code, in accordance with the quantization step supplied from the quantizer 332. The resulting converted quantization coefficients are outputted to a buffer not illustrated. The quantization coefficients and the quantization step are also supplied to an inverse quantizer 338 which dequantizes the quantization coefficients in accordance with the quantization step so as to convert the same to DCT coefficients. The DCT coefficients are supplied to the inverse DCT unit 340 which performs inverse DCT on the DCT coefficients. The obtained inverse DCT coefficients are then supplied to the arithmetic unit 348.

The arithmetic unit 348 receives the inverse DCT coefficients from the inverse DCT unit 340 and the data from the motion compensator 324 depending on the location of switch 344. The arithmetic unit 348 sums the signal prediction residuals) from the inverse DCT unit 340 to the predicted picture from the motion compensator 324 to locally decode the original picture. However, if the predition mode indicates intra-coding, the output of the inverse DCT unit 340 may be directly fed to the frame memory. The decoded picture obtained by the arithmetic unit 340 is sent to and stored in the frame memory so as to be used later as a reference picture for an inter-coded picture, forward predictive coded picture, backward predictive coded picture, or a bi-directional predictive coded picture.

The enhancement encoder 314 comprises a motion estimator 354, a motion compensator 356, a DCT circuit 368, a quantizer 370, a VLC unit 372, a bitrate controller 374, an inverse quantizer 376, an inverse DCT circuit 378, switches 366 and 382, subtractors 358 and 364, and adders 380 and 388. In addition, the enhancement encoder 314 may also include DC-offsets 360 and 384, adder 362 and subtractor 386. The operation of many of these components is similar to the operation of similar components in the base encoder 312 and will not be described in detail.

The output of the arithmetic unit 340 is also supplied to the upsampler 350 which generally reconstructs the filtered out resolution from the decoded video stream and provides a video data stream having substantially the same resolution as the high-resolution input. However, because of the filtering and losses resulting from the compression and decompression, certain errors are present in the reconstructed stream. The errors are determined in the subtraction unit 358 by subtracting the reconstructed high-resolution stream from the original, unmodified high resolution stream.

According to one embodiment of the invention illustrated in FIG. 3, the original urnodified high-resolution stream is also provided to the motion estimator 354. The reconstructed high-resolution stream is also provided to an adder 388 which adds the output from the inverse DCT 378 (possibly modified by the output of the motion compensator 356 depending on the position of the switch 382). The output of the adder 388 is supplied to the motion estimator 354. As a result, the motion estimation is performed on the upscaled base layer plus the enhancement layer instead of the residual difference between the original high-resolution stream and the reconstructed high-resolution stream. This motion estimation produces motion vectors that track the actual motion better than the vectors produced by the known systems of FIGS. 1 and 2. This leads to a perceptually better picture quality especially for consumer applications which have lower bit rates than professional applications.

Furthermore, a DC-offset operation followed by a clipping operation can be introduced into the enhancement encoder 314, wherein the DC-offset value 360 is added by adder 362 to the residual signal output from the subtraction unit 358. This optional DC-offset and clipping operation allows the use of existing standards, e.g., MPEG, for the enhancement encoder where the pixel values are in a predetermined range, e.g., 0 . . . 255. The residual signal is normally concentrated around zero. By adding a DC-offset value 360, the concentration of samples can be shifted to the middle of the range, e.g., 128 for 8 bit video samples. The advantage of this addition is that the standard components of the encoder for the enhancement layer can be used and result in a cost efficient (re-use of IP blocks) solution.

According to one embodiment of the invention, the enhancement output stream from the VLC unit 372 is supplied to a split vector unit 390. The motion estimation vectors from the base layer are also supplied to the split vector unit 390. The split vector unit 390 subtracts processed motion estimation vectors of the base layer from the motion estimation vectors of the enhancement layer to produce a residual of the motion estimation vectors. The residual signal is then transmitted. By reducing the redundancy of the vectors of the enhancement layer, the bitrate of the enhancement layer is reduced.

In one embodiment of the invention, the base motion vectors are scaled in the split vector unit 390 (or a scaling unit not illustrated in FIG. 3) to form the processed base motion vectors. The scaling can be performed using a linear or non-linear scaling factor. For non-linear scaling, the horizontal portion of the base motion vector is scaled by a first scaling factor and the vertical portion of the base motion vector is scaled by a second scaling factor. In addition, it may be unclear from which base macroblock the base vectors should be taken. According to one embodiment of the invention, the base macroblock which covers most of the intended enhancement macroblock is selected. In another embodiment of the invention, the base motion vectors from some or all of the base macroblocks which cover at least a portion of the intended enhancement macroblock are selected. The corresponding selected base motion vectors from each base macroblock can then be averaged in some known manner to produce a set of base motion vectors which are then scaled.

FIG. 4 illustrates a decoder 400 according to one embodiment of the invention for decoding the base and enhancement streams produced by the encoder 300. The base stream is decoded in a base decoder 402. The decoded base stream is then upconverted by an upconverter 404. The upconverted base stream is supplied to an addition unit 406. The vectors from the base layer are sent from the base decoder 402 to the merge vector unit 408. The base motion vectors must, however, first be scaled by the merge vector unit 408 (or a scaling device not illustrated in FIG. 4) using the same scaling factors as were used in the split vector unit 390. The merge vector unit 408 adds the processed base vectors to the residual signal in the enhancement stream. Thus, the motion vectors of the enhancement stream are reconstituted and the entire enhancement stream can now be decoded by an enhancement decoder 410. The decoded enhancement stream is then added to the upconverted base stream by the addition unit 406 to create the full output signal of the decoder 400. While the illustrative embodiment illustrated in FIG. 4 refers to motion vectors, it will be understood by those skilled in the art that the invention applies to other base and enhancement features as well.

The above-described embodiments of the invention enhance the efficiency of spatial scalable compression schemes by lowering the bitrate of the enhancement layer by only transmitting a residual of the enhancement features in the enhancement layer. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. An apparatus for performing spatial scalable compression of an input video stream including an encoder for encoding and outputting the video stream in a compressed form, comprising:
a base layer encoder (312) for encoding a base stream which comprises base features;
an enhancement layer encoder (314) for encoding a residual signal to produce an enhancement stream comprising enhancement features, wherein the residual signal is the difference between original frames of the input video stream an upscaled frames from the base layer;
a unit (390) for subtracting a processed version of the base features from the enhancement features in the enhancement stream.

2. The apparatus according to claim 1, wherein said base features are base motion vectors and said enhancement features are enhancement motion vectors.

3. The apparatus according to claim 2, wherein the base motion vectors are scaled to form the processed base motion vectors.

4. The apparatus according to claim 3, wherein a linear scaling factor is used to scale the base motion vectors.

5. The apparatus according to claim 3, wherein a non-linear scaling factor is used to scale the base motion vectors.

6. The apparatus according to claim 5, wherein a first scaling factor scales a horizontal portion of the base motion vectors and a second scaling scales a vertical portion of the base motion vectors.

7. The apparatus according to claim 3, wherein the base motion vectors are taken from a base macroblock which substantially covers an intended enhancement macroblock.

8. The apparatus according to claim 7, wherein the base motion vectors a taken from a plurality of base macroblocks which cover at least a portion of the intended enhancement macroblock, wherein corresponding base motion vectors from all of the plurality of base macroblocks which at least partially cover the intended enhancement macroblock are combined into-one set of base motion vectors which are then scaled.

9. The apparatus according to claim 8, wherein the corresponding base motion vectors from all of the plurality of base macroblocks are averaged or weighted averaged to create the set of base motion vectors which are then scaled.

10. A layered encoder for encoding an input video stream, comprising:
a downsampling unit (320) for reducing the resolution of the video stream;
a first motion estimation unit (322) which calculates base motion vectors for each frame of the downsampled video stream;
a first motion compensation unit (324) which receives the base motion vectors from the first motion estimation unit and produces a first predicted stream;
a first subtraction unit (325) for subtracting the first predicted stream from said downsampled video stream to produce a base stream;
a base encoder (312) for encoding a lower resolution base stream;
an upconverting unit (350) for decoding and increasing the resolution of the base stream to produce a reconstructed video stream;
a second motion estimation unit (354) which receives the input video stream and the reconstructed video stream and calculates enhancement motion vectors for each frame of the received streams based upon an upscaled base layer plus enhancement layer;
a second subtraction unit (358) for subtracting the reconstructed video stream from the input video stream to produce a residual stream;
a second motion compensation unit (356) which receives the motion vectors from the motion estimation unit and produces a second predicted stream;
a third subtraction unit (364) for subtracting the second predicted stream from the residual stream;
an enhancement encoder (314) for encoding the resulting stream from the subtraction unit and outputting an enhancement stream; arid
a split vector unit (390) for subtracting a processed version of the base motion vectors from the enhancement motion vectors in the enhancement stream.

11. A method for providing spatial scalable compression of an input video stream, comprising the steps of:
encoding a base stream which comprises base features;
encoding a residual signal to produce an enhancement stream comprising enhancement features, wherein the residual signal is the difference between original frames of the input video stream an upscaled frames from the base layer;
subtracting a processed version of the base features from the enhancement features in the enhancement stream.

12. The method according to claim 11, wherein said base features are base motion vectors and said enhancement features are enhancement notion vectors.

13. A decoder for decoding compressed video information, comprising:
a base stream decoder (402) for decoding a received base stream;
an upconverting unit (404) for increasing the resolution of the decoded base stream;
a merge unit (408) for adding processed base features produced by the base stream decoder to a residual signal in a received enhancement stream;
an enhancement stream decoder (410) for decoding an output signal from the merge unit; and
an addition unit (406) for combining the upconverted decoded base stream and the decoded output of the merge unit to produce a video output.

14. The decoder according to claim 13, wherein said base features are base motion vectors and said enhancement features are enhancement motion vectors.

15. The decoder according to claim 14, wherein the base motion vectors are scaled to form the processed base motion vectors.

16. The decoder according to claim 15, wherein a linear scaling factor is used to scale the base motion vectors.

17. The decoder according to claim 15, wherein a non-linear scaling factor is used to scale the base motion vectors.

18. The decoder according to claim 17, wherein a first scaling factor scales a horizontal portion of the base motion vectors and a second scaling scales a vertical portion of the base motion vectors.

19. The decoder according to claim 15, wherein the base motion vectors are taken from a base macroblock which substantially covers an intended enhancement macroblock.

20. The decoder according to claim 19, wherein the base motion vectors are taken from a plurality of base macroblocks which cover at least a portion of the intended enhancement macroblock, wherein corresponding base motion vectors from all of the plurality of base macroblocks which at least partially cover the intended enhancement macroblock are combined into one set of base motion vectors which are then scaled.

21. The decoder according to claim 20, wherein the corresponding base motion vectors from all of the plurality of base macroblocks are averaged or weighted averaged to create the set of base motion vectors which are then scaled.

22. A method for decoding compressed video information received in a base stream and an enhancement stream, comprising the steps of:
decoding the received base stream;
increasing the resolution of the decoded base stream;
adding processed base features produced by the base stream decoder to a residual signal in the received enhancement stream to form a combined signal;
decoding the combined signal; and
combining the upconverted decoded base stream and the decoded combined signal to produce a video output.
